(19) United States
(12) Patent Application Publication
(10) Pub. No.: US 2003/0108262 A1
(43) Pub. Date: Jun. 12, 2003

(54) Lightweight bearing cage

(76) Inventor: Dale K. Bell, Ortonville, MI (US)

Correspondence Address: CARLSON, GASKEY & OLDS, P.C., 400 WEST MAPLE ROAD, SUITE 350, BIRMINGHAM, MI, 48009, US

(21) Appl. No.: 10/016,401

(22) Filed: Dec. 10, 2001

(51) Int. Cl. F16C 43/04

(52) U.S. Cl. 384/585

(57) ABSTRACT

A drivetrain assembly includes a housing is provided having an aperture through a portion of the housing. A bearing cage is disposed in the aperture and secured to the portion. The cage includes an opening therethrough for receiving a driven shaft of a drivetrain component. A bearing assembly rotatably supports the driven shaft in the bearing cage. The bearing assembly includes an outer race with at least one protrusion extending therefrom received in the bearing cage for preventing rotation of the outer race relative to the cage. The bearing cage is preferably constructed from a lightweight polymer material and molded about a portion of the outer race during the bearing cage forming process.

### BACKGROUND OF THE INVENTION

This invention relates to a bearing cage assembly for vehicle drivetrains, and more particularly, the invention relates to bearing cages for supporting a driven shaft in such applications as axles.

Drive axle assemblies include driven shafts for transmitting the rotational drive from the driveline to the axle shafts within the axle assembly. The driven shaft may be an input shaft, through shaft, or pinion shaft in a tandem axle. The driven shafts typically includes a yoke at one end coupled to a driveshaft through a universal joint. In the case of an input and pinion shaft, pinion gear arranged opposite the yoke engages a ring gear coupled to the axle shafts, typically through a differential assembly. To facilitate assembly of the axle assembly, the driven shaft is supported within a bearing cage that is inserted into an aperture into the axle assembly. The bearing cage is fastened typically to the axle assembly using threaded fasteners. A bearing assembly supports the driven shaft for rotation within the bearing cage.

Bearing cages are also used to support wheel ends of the axle shafts. Also, bearing cages have been used to support the output shaft of the transmission. Prior art bearing cages used in the above applications have been cast metal, which is rather heavy. The metal cage is machined to receive the bearing assembly in a press-fit relation. The bearing cage assembly is lightly loaded in some applications, that is, the through shaft assembly is not subjected to high forces. As a result, a heavy cast metal pinion cage may not be necessary. Therefore, what is needed is a lightweight bearing cage designed to support the pinion and/or shaft bearing assemblies.

### SUMMARY OF THE INVENTION AND ADVANTAGES

The present invention provides a drivetrain assembly including a housing having an aperture through a portion of the housing. A bearing cage is disposed in the aperture and secured to housing portion. The cage includes an opening therethrough for receiving a driven shaft. A bearing assembly and usually but not always including a seal assembly, supports the driven shaft in the bearing cage. The bearing assembly includes an outer race with at least one protrusion extending therefrom received in the bearing cage for preventing rotation of the outer race relative to the cage. The bearing cage is preferably constructed from a lightweight polymer material and molded about a portion of the outer race during the bearing cage forming process.

Accordingly, the above invention provides a lightweight bearing cage designed to support the driven shaft bearing assembly that supports the driven shaft.

### BRIEF DESCRIPTION OF THE DRAWINGS

Other advantages of the present invention can be understood by reference to the following detailed description when considered in connection with the accompanying drawings wherein:

FIG. 1 is a partial cross-sectional view of a bottom half of an axle housing including the present invention bearing cage;

FIG. 2 is a partial cross-sectional view of a top half of an axle housing depicting another embodiment of the present invention bearing cage;

FIG. 3 is a cross-sectional view of the bearing cage taken along lines 3-3 of FIG. 1;

FIG. 4 is a flowchart of a bearing cage forming process of the present invention; and

FIG. 5 is a schematic of a drivetrain utilizing the present invention bearing cage.

### DETAILED DESCRIPTION OF THE PREFERRED EMBODIMENT

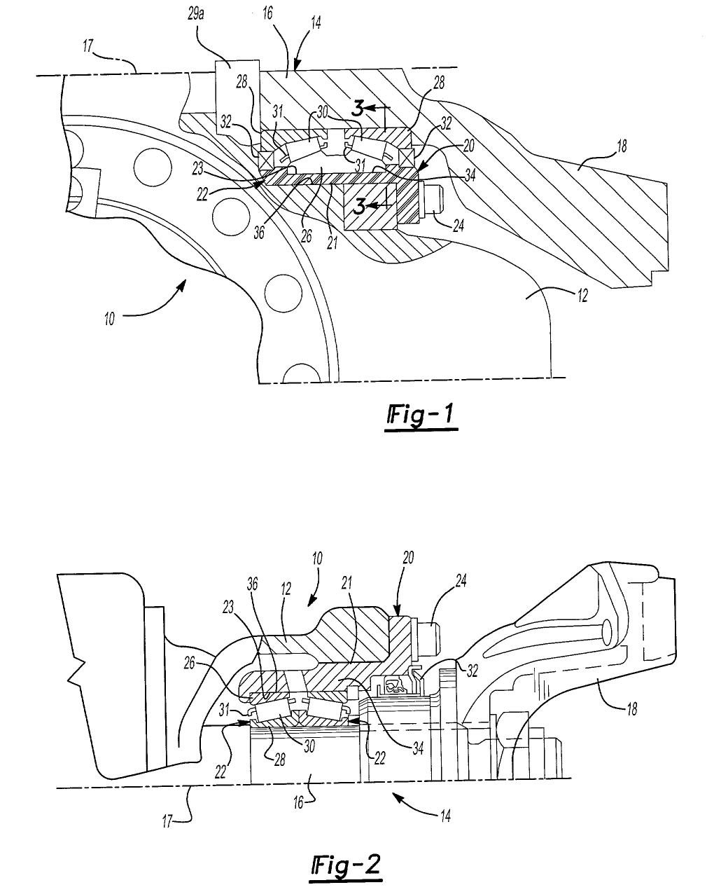

A bottom half of through shaft cage assembly 10 is shown in FIG. 1. The drive axle assembly 10 includes an axle housing 12, which houses opposing axle shafts (not shown) typically coupled by a differential assembly (not shown). A through shaft 14, which is coupled to a driveshaft (not shown) at yoke 18 via a universal joint (not shown), transmits rotational drive from the forward axle to a rearward axle in a tandem axle. The through shaft 14 includes a shaft portion 16 that is rotatable about a rotational axis 17. The housing 12 includes an aperture 21 for facilitating installation of the through shaft 14 and assembly of the axle housing 12.

A bearing cage 20 includes an opening 23 with the shaft portion 16 arranged within the opening 23. The bearing cage 20 is secured to the housing 12 by fasteners 24. A bearing assembly 22 rotationally supports the through shaft 16 within the bearing cage 20. As shown in FIG. 1, the bearing assembly 22 may be a unitized tapered bearing assembly. Unitized bearing assemblies provide improvements over conventional bearing assemblies such as bearing spread, adjustment and lubrication capabilities, and improved sealing. With continuing reference to FIG. 1, the bearing assembly 22 includes an outer race or cup 26 supported by the through shaft cage 20 and an inner race or cone 28 supporting the through shaft 16. A plurality of tapered rollers 30 retain inner space relationship to one another by a retainer 31 are arranged between the cup 26 and cone 28 for permitting rotation therebetween. Seals 32 are arranged between the cup 26 and cones 28 to retain lubricant within the bearing assembly 22 and prevent debris from entering. The yoke 18 may be assembled to the through shaft 14 with a nut (not shown) at the onto board side, as is typical, or with a nut 29a or snap ring inside the bearing cone 28 to set a desired bearing preload/endplay condition.

A conventional bearing assembly 22 is shown in FIG. 2 like reference numerals are used to indicate like components. Unlike the unitized bearing assembly shown in FIG. 1, individual cups 26 are utilized for each cone 28. The bearing assemblies 22 shown in FIGS. 1 and 2 include an outer surface of a cup 26 that is in engagement with an inner cage surface 34, which defines the opening 23.

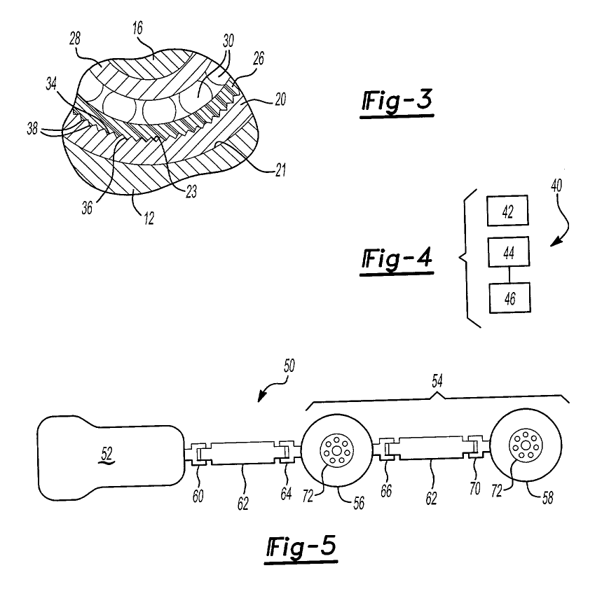

The bearing cage 20 of the present invention is formed from a lightweight material, preferably from a polymer material, and more preferably from a nylon material such as PA66GF50. Because through shafts 14 tend to be lightly loaded, a metal bearing cage typically used in the prior art may not be necessary. As a result, a polymer bearing cage 20 may be used, which may result in a weight savings of approximately 5.5 pounds or more. The outer race of the bearing assembly 22 may not be press-fit into the bearing cage 20 in the typical manner due to the different coefficients of thermal expansion and other material properties. To this end, it is preferable to include at least one protrusion 38 extending from the outer surface 36 of the outer race 26 to lock the race 26 and cage 20 together, as shown in FIG. 3. More preferably, a plurality of protrusions or serrations extend from the outer surface 36 to lock the outer race 26 to the bearing cage 20.

The bearing cage 20 may be formed using a process indicated at 40 in FIG. 4. An outer race may be provided having at least one protrusion, as indicated at 42. The outer race may be placed into a mold. Material, such as a nylon material, may be injected into the mold about a portion of the outer race to ensure that the outer race does not move relative to the bearing cage 20, as indicated at 44. During the molding process, the protrusion or serrations are embedded into the pinion cage material as indicated at 46. In this manner, a lightweight bearing cage 20 may be provided having a bearing assembly 22 with its outer race affixed to the cage. A light-weight metal matrix may also be used to form the cage 20 such a aluminum and silicon carbide.

As discussed above, bearing cages are used for various drivetrain components to rotationally support a driven shaft. A drivetrain 50 is shown in FIG. 5. The drivetrain 50 includes a transmission 52 connected to a tandem axle system 54 including a forward axle 56 and a rearward axle 58. The transmission 52 includes an output shaft 60 coupled to an input shaft 54 of the forward axle 56 by a drive shaft 62. In this manner, the forward axle 56 receives rotational drive from the transmission 52. Rotational drive is transmitted from the forward axle 56 to the rearward axle 58 by a drive shaft 62 that is coupled to a through shaft 66 of the forward axle and a pinion shaft 70 of the rearward axle. In this manner, the wheel end 72 of both the forward axle 56 and the rearward axle 58 receive rotational drive from the transmission 52. Although the present invention bearing cage has been discussed relative to the through shaft 66 of the forward axle 56, it is to be understood that the present invention bearing cage may also be used to support the transmission output shaft 60, the axle input shaft 64, and the pinion shaft 70.

The invention has been described in an illustrative manner, and it is to be understood that the terminology that has been used is intended to be in the nature of words of description rather than of limitation. Obviously, many modifications and variations of the present invention are possible in light of the above teachings. It is, therefore, to be understood that within the scope of the appended claims the invention may be practiced otherwise than as specifically described.

What is claimed is:

1. A drivetrain assembly comprising:
a housing having an aperture through a portion of said housing;
a bearing cage disposed in said aperture and secured to said portion; said cage including an opening therethrough;
a driven shaft including a shaft portion disposed in said opening; and
a bearing assembly supporting said shaft portion in said cage, said bearing assembly including an outer race with at least one protrusion extending therefrom received in said cage preventing rotation of said outer race relative to said cage.

2. The assembly according to claim 1, wherein said bearing assembly is a tapered bearing assembly and said outer race is a cup.

3. The assembly according to claim 1, wherein said bearing assembly is a unitized bearing assembly including spaced apart inner races each supporting a set of rolling bearing elements, and a common outer race supporting both of said sets of rolling bearing elements, wherein said common outer race includes said at least one protrusion.

4. The assembly according to claim 1, wherein said outer race includes a plurality of protrusions arranged radially about an outer surface of said outer race.

5. The assembly according to claim 1, wherein said cage is constructed from a polymer material.

6. The assembly according to claim 5, wherein said polymer material is a nylon material.

7. The assembly according to claim 1, wherein said cage is constructed from a metal matrix containing aluminum and silicon carbide.

8. A drivetrain assembly comprising:
a housing having an aperture through a portion of said housing;
a bearing cage disposed in said aperture and secured to said portion, said cage including an opening therethrough;
a driven shaft including a shaft portion disposed in said opening; and
a bearing assembly supporting said shaft portion in said cage, wherein said cage is constructed from a polymer material.

9. The assembly according to claim 8, wherein the bearing assembly includes an outer race with at least one protrusion extending therefrom received in said cage preventing rotation of said outer race relative to said cage.

10. The assembly according to claim 9, wherein said outer race includes a plurality of protrusions arranged radially about an outer surface of said outer race.

11. The assembly according to claim 9, wherein said bearing assembly is a tapered bearing assembly and said outer race is a cup.

12. The assembly according to claim 8, wherein said bearing assembly is a unitized bearing assembly including spaced apart inner races each supporting a set of roller bearings, and a common outer race supporting both sets of roller bearing elements wherein said common outer race includes at least one protrusion extending therefrom received in said cage preventing rotation of said outer race relative to said cage.

13. The assembly according to claim 8, wherein said housing is an axle housing and said driven shaft is a pinion shaft.

14. The assembly according to claim 8, wherein said housing is an axle housing and said driven shaft is an input shaft.

15. The assembly according to claim 8, wherein said housing is an axle housing and said driven shaft is a through shaft.

16. The assembly according to claim 8, wherein said housing is an axle housing and said driven shaft is a wheel end portion of an axle shaft.

17. The assembly according to claim 8, wherein said housing is a transmission housing and said driven shaft is an output shaft.

18. A method of forming a bearing cage for a drivetrain assembly comprising the steps of:
a) placing a bearing assembly having an outer race with at least one protrusion into a mold;
b) injecting a material into the mold about a portion of the outer race; and
c) embedding the at least one protrusion in the material.

19. The method according to claim 18, wherein step b) includes injecting a polymer material into the mold.

20. The method according to claim 18, wherein step c) includes injecting the material about at least one protrusion.
